(19) United States
(12) Patent Application Publication
(10) Pub. No.: US 2011/0184323 A1
(43) Pub. Date: Jul. 28, 2011

(54) EPICONDYLITIS TREATMENT

(76) Inventor: Ranjan VHADRA, Guernsey (GB)

(21) Appl. No.: 12/692,072

(22) Filed: Jan. 22, 2010

(51) Int. Cl. A61H 1/00

(52) U.S. Cl. 601/46

(57) ABSTRACT

A method of treating epicondylitis comprising applying to the elbow of a patient suffering from epicondylitis a vibrating device.

This invention relates to the treatment of epicondylitis, in particular lateral epicondylitis (also known as tennis elbow) or medical epicondylitis (also known as golfer's elbow) in humans, and to a device suitable for the treatment of this condition.

### BACKGROUND

Epicondylitis is an age related condition which afflicts numerous people throughout the globe. Typically, the condition manifests itself between the ages of 30 and 55 and is caused, at least in part, as type I collagen which forms tendons degrades. If the tendon was to degrade too much it would break so to prevent breakage the body prevents usage by causing pain when the tendon is used.

Epicondylitis usually self heals with time and rest of the afflicted tendon and associated bone and muscle is thus a common treatment strategy. To minimise use of the tendon, a patient may wear a brace which prevents movement of the tendon in question. The healing process can, however, be slow and any acceleration of the healing process is obviously advantageous as the affliction can be debilitating.

It is believed that the cause of epicondylitis is lack of blood supply to the tendon and associated joint and muscle. This causes tiny tears in parts of the tendon and muscle coverings. There may also be associated inflammation. Once injured the afflicted area often tears again which may lead to haemorrhaging and the formation of granulated tissue and calcium deposits within surrounding tissues.

Various treatments for epicondylitis are proposed in the art. Applying heat and ice in combination is a common treatment as ice controls swelling and heat heals and promotes blood flow and also relieves tightness and pain. NSAIDS may also be administered to reduce inflammation.

Physiotherapy is also widely used to treat epicondylitis. Manual physiotherapy may be an important part of the treatment and can take the form of joint mobilisations/manipulations and/or extensor muscle tissue mobilisations. The patient may also be required to enter into a regime of exercise to accelerate recovery. More sophisticated treatments include ultrasound and laser treatment both of which can be used to reduce inflammation and promote collagen production although the current evidence for their efficacy is inconclusive. Steroid injections are also used to treat epicondylitis but there is a risk of later recurrence with this treatment option.

As a final resort, surgery can be employed. Surgery can allow the formation of new blood vessels that increase the oxygen supply to the afflicted area and therefore allow the natural healing process to proceed.

There are a number of alternative therapies available too. For example, acupuncture has also been tried in this field to relieve the symptoms of epicondylitis. There still remains, however, the need to devise further treatments for this common affliction, in particular, simple and economic treatments which can be carried out by the patient without a skilled medical practitioner being present.

The present inventor has now realised that a highly effective treatment for epicondylitis, in particular lateral epicondylitis or medical epicondylitis, is mild vibration therapy. The use of vibration therapy has been surprisingly found to have potential in reduction of pain and acceleration of recovery from epicondylitis, in particular accelerated healing of both bone and tendon. Most usefully, vibration therapy can be applied at home by the patient without the presence of a medical practitioner. The vast majority of the treatments above require an expert physiotherapist, sonographer or doctor to administer the injection, carry out massage, apply ultrasound and so on. Vibration can be applied to the afflicted area by the patient simply by applying a vibrating device to the area of the body in question. In this way, the treatment can be carried out almost anywhere, at any time and at any frequency. This treatment is thus even more useful (and effective) than ice and heat therapy as it does not require a source of ice and a source of heat. The user need carry with him only a small vibrating device, perhaps no larger than a mobile phone, which he can attach to his elbow to carry out treatment anywhere he may be.

### SUMMARY OF INVENTION

Thus, viewed from one aspect the invention provides a method of treating epicondylitis comprising applying to the elbow of a patient suffering from epicondylitis a vibrating device.

Alternatively viewed the invention provides a method of treating epicondylitis in a patient suffering from epicondylitis comprising vibrating the elbow using a vibrating device.

Viewed from a further aspect the invention provides a method of stimulating blood flow in the elbow comprising applying a vibrating device to the elbow.

### BRIEF DESCRIPTION OF THE FIGURES

FIG. 1 shows a cross section of the arm.

FIG. 2 shows a vibrating device of the invention.

FIG. 3 shows the device of the invention in cross section.

FIG. 4 is a depiction of the device in use.

### DETAILED DESCRIPTION OF INVENTION

The present invention requires the use of a vibrating device to generate the vibrations required for treatment of epicondylitis. Thus, the necessary vibrations are generated at low frequency and mechanically as opposed to electromagnetically (e.g. using a laser) or by shockwave (e.g. using ultrasound). Conveniently, the vibration will be generated by a vibrating device as described herein.

The use of low frequency mechanically generated vibration is important as the use of a simple mechanical vibrating device gives rise to a different type of vibration than shockwave or light therapy and is a much cheaper and more readily applied form of vibration therapy.

Low frequency vibrations generated mechanically and applied locally to the injured tendon stimulate the formation of new blood vessels (angiogenesis) thereby increasing the blood supply to the afflicted tendon and associated muscles and joints and thereby accelerating recovery. Low frequency vibrations also promote bone healing. Thus, to treat epicondylitis, the elbow is contacted with the vibrating device which may be held against the elbow by any convenient means. In this way, vibrations are applied directly to the injured body area, in particular the injured tendon and associated muscle. Preferably, the device should contact the skin directly rather than through clothing or the like.

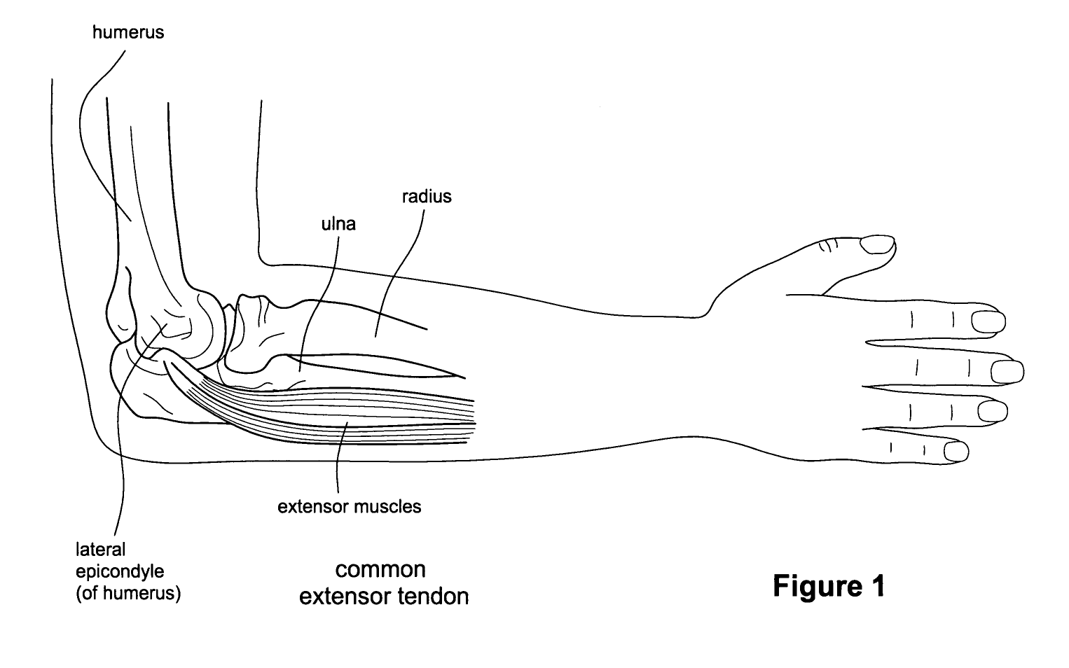

The vibrating device needs to be placed against the tendon where the affliction is located. Thus, for lateral epicondylitis (tennis elbow) the device must be placed against the lateral epicondyle of the humerous and its associated tendon, as shown in FIG. 1, i.e. on the outside of the elbow. For medical epicondylitis (golfers elbow), the device must be located against the medical epicondyle and its associated tendon, i.e. on the inside of the elbow. The patient can be provided with clear instruction on where to place the device through a user guide or by a doctor, physiotherapist and so on.

The device can be applied to the elbow by any convenient means. Thus, in one embodiment a patient may simply hold the device against his elbow. Preferably however, the device will be adapted to attach to the elbow in some fashion. This may be achieved using a strap which can be put around the elbow and device and tightened to ensure that the device does not fall and that the device contacts the elbow with sufficient pressure that the vibrations are transmitted to the damaged tendon. Alternatively it may be possible to attach the device using some form of adhesive or the device could be held in place under tight fitting clothing or under an elbow support, e.g. a neoprene type support often worn by athletes. The skilled man can devise many ways of attaching the device to the body so that it is arranged to contact the appropriate part of the elbow.

The vibrating device produces mild vibrations, similar to those produced by a vibrating mobile telephone. It is important therefore that the device does not subject the elbow to strong high frequency vibrations as such vibrations could actually be damaging and painful. The skilled man will be readily able to devise a device that produces an acceptable level of vibration. For example, devices powered by less than 3 watts, preferably less than 1 watt may be suitable here. As noted above, vibration levels may be similar to those achieved by mobile telephones or by a massage device.

Thus, the frequency of vibration may be 100 to 300 oscillations per minute, e.g. 150 oscillations per minute, i.e. around 2 to 5 Hz. It is stressed that the vibrating device of the invention operates at low frequency, i.e. less than 1 kHz and does not therefore encompass ultrasonic treatment and the like.

The duration of each vibration therapy treatment can vary across wide limits but typically sessions of 5 to 20 minutes e.g. 7 to 15 minutes, especially about 10 minutes are appropriate. Some patients may choose to leave the device vibrating on the body throughout the day to maximise recovery potential.

Therapy sessions can be repeated many times daily if required. Conveniently, the vibration therapy will be employed 2 to 5, e.g. 3 times a day.

The skilled man can devise a wide variety of vibrating devices suitable for use in the invention but it is stressed that the vibrations must be low frequency mechanical vibrations generated by some form of oscillating device as opposed to sound wave or electromagnetic wave induced vibration. Vibration itself can be achieved using known technology, e.g. that used in mobile phones. For example, a motor can drive a gear on which is set a weight mounted off-centre on the gear. When the motor spins the gear/weight combination the off-centre mounting causes a vibration. In a preferred embodiment, the vibrating device of use in the invention comprises such a gear/weight combination.

The whole device can vibrate if desired although preferably, vibration is primarily confined to a particular part of the device which can be arranged to contact the elbow in the position where treatment is desired. In a preferred embodiment, the device comprises a vibrating member which is movable with the housing of the device and it is only this part of the device which vibrates on activation. Ideally the vibrating means, e.g. gear/weight combination, contacts the vibrating member which thus vibrates independently from the rest of the device and thus provides a specific area of vibration which can be applied to the elbow.

The vibrating member preferably projects from the outer surface of the housing providing a vibrating surface which can be arranged to contact the elbow. The member which vibrates can be any shape but a circular disk shaped projection is preferred as this is ideally shaped to contain the gear/weight combination.

The housing of the device may have a planar surface adapted to contact the skin of the elbow/arm or may be moulded to minor the contours on the elbow/arm, e.g. the housing may mirror the shape of the outside of the elbow for lateral epicondylitis treatment. The housing is preferably formed from plastic or rubber type material. Moulding can therefore can be readily achieved using well known plastic moulding technology.

The size of the device could be varied to take account of different arm sizes although a single sized device is suitable for epicondylitis treatment in all patients. Typically, the device may be between 5 and 10 cm in length and is thus readily portable. The projecting vibrating member may be of the order of 1 to 2 cm in length (e.g. in diameter). It may project from the housing by the order of 0.5 to 2 mm.

The device is preferably battery powered so that no mains connection is needed although, if required, a device which can be run from mains electricity or run on both battery and mains power can be devised. Battery power is preferred and the device may use a rechargeable or non rechargeable battery. Most conveniently, the device can be run on AA or AAA batteries.

The device may be programmable so that the user may set a fixed period during which vibration will occur. Thus, the device may contain a printed circuit board connected to the vibrating means which relays information on the duration of treatment inputted into the device by the user. The device may also include a screen displaying, for instance, the set vibration time and elapsed time or time to end of the treatment period once the treatment begins. A simpler device may have only an activating button which causes vibration for a predetermined period, e.g. 10 minutes.

Such a device is new and forms a further aspect of the invention. Thus, viewed from another aspect the invention provides a device for the treatment of epicondylitis comprising;

a housing suitable for attachment to the arm of a patient and having at least one external surface; and

a vibrating member movably attached to the housing such that at least a part of the vibrating member projects from said external surface of the housing wherein in use the vibrating member is adapted to contact the elbow.

Preferably, the vibrating member is in contact with a vibrating means arranged to cause vibration of the member.

Viewed from another aspect the invention provides an epicondylitis treatment device comprising a housing arranged to contact the arm of a patient and a vibrating means inside the housing, said vibrating means being adapted to vibrate at least a part of the device upon actuation.

Viewed from another aspect the invention describes a kit comprising a vibrating device as hereinbefore defined and instructions for the use thereof in the treatment of epicondylitis.

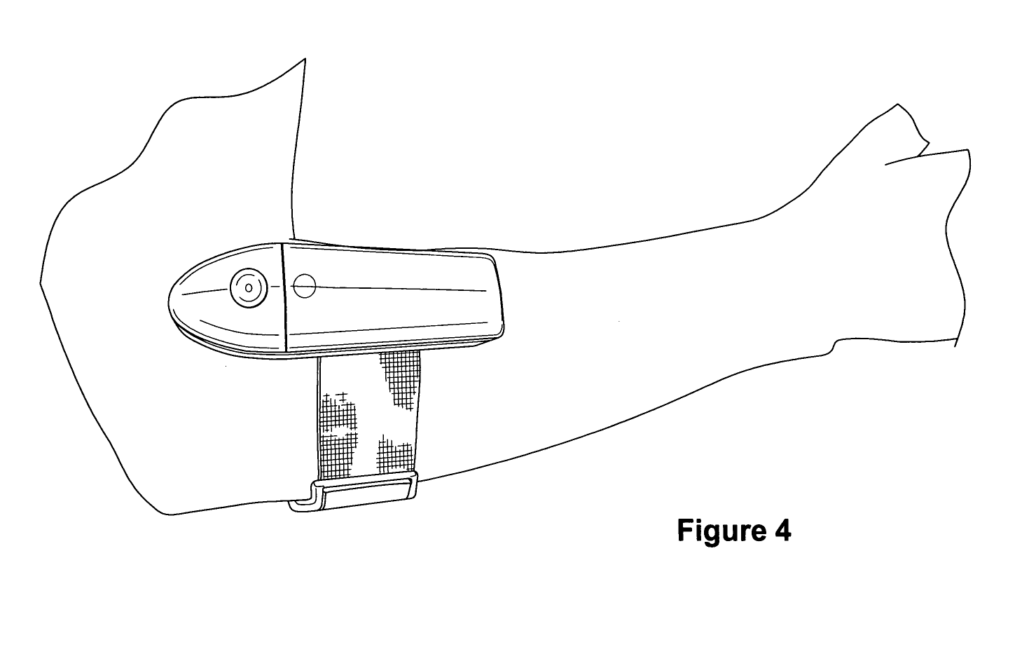

The inventors have further realised that due to the position of the lateral epicondyle, it is not a simple matter to ensure that the vibrating protrusion is located above the appropriate area of the body. As the tendon is on the elbow joint, the use of a conventional strap is not possible as that strap would need to be positioned on the elbow. Such a strap would prevent movement of the elbow. The present inventors have realised therefore that the projection through which vibrations are transferred to the lateral epicondyle should preferably be spaced from the strap which holds the rest of the device in place on the arm. The strap can be placed above or below the elbow on a part of the arm which does not bend thus allowing elbow movement. The strap and device however, are positioned so that the spaced projection still makes contact with the lateral epicondyle. This is depicted in FIG. 4.

Viewed from another aspect therefore the invention provides a device for the treatment of epicondylitis comprising;

a housing;

a vibration generating device within the housing;

a vibration transmitting member projecting from the housing; and

a strap on the housing for holding the device against a patient's arm,

wherein the vibration transmitting member projects from the housing at a position which is spaced from the strap, so that the vibration transmitting member can supply vibrations to the patient's elbow when it is strapped to the patient's arm.

There may be for example, a gap of at least 1 cm, e.g. at least 2 cm, preferably 3 to 10 cm, such as 3 to 5 cm between the edge of the strap nearest the projection and the centre of the projection itself. The strap is preferably positioned therefore up or down the arm from the elbow and the vibration transmitting member is spaced from the strap longitudinally up or down the arm, as opposed to transversely across the arm (i.e. in parallel). The strap preferably passes all the way around the arm of the patient.

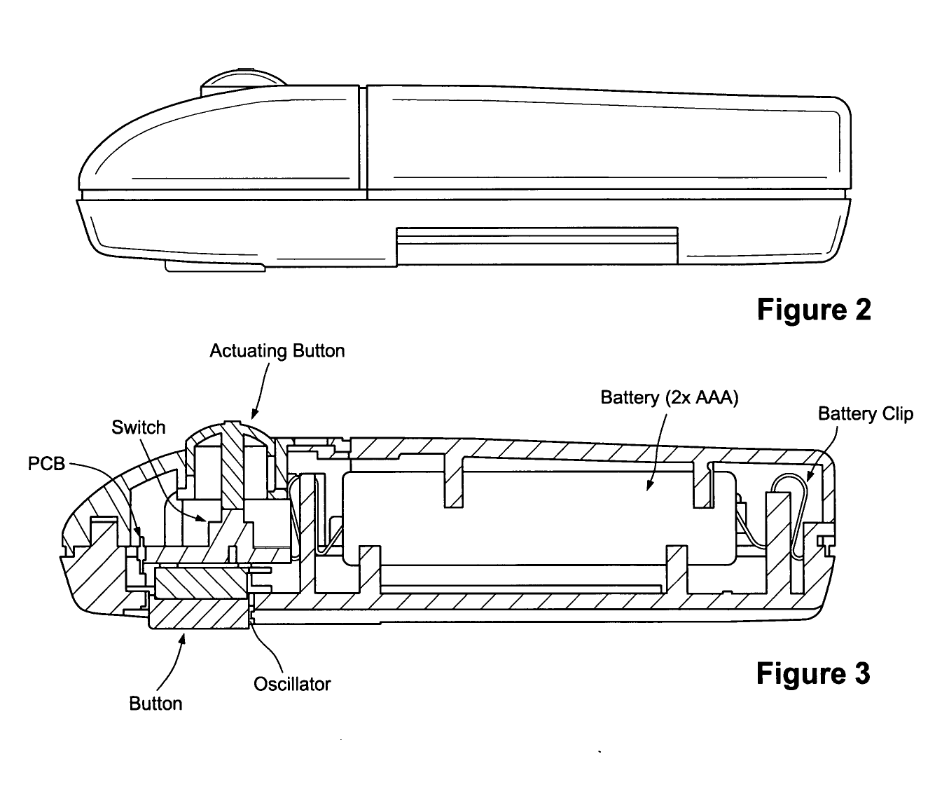

The skilled man is able to devise all kinds of mechanical devices for use in the treatment of epicondylitis. A highly preferred device is described in FIGS. 2 and 3.

In FIG. 2, device (1) has a housing (2) with battery insert panel (3), actuating button (4) and vibrating member (5) projecting from the housing.

FIG. 3 shows the device in cross section. A vibrating means (6) is positioned above and in contact with member (5). The disk acts to isolate the stimulus and direct it towards the tendon. In use, the member (5) is positioned directly over the injured tendon and effects treatment of epicondylitis as the member vibrates.

A control printed circuit board (7) is activated by switch (8) when actuator button (4) is depressed. The device is powered by 2 AAA batteries (not shown), held in battery cavity (9).

In use, the device may be strapped onto the elbow of the patient. The device housing may therefore be provided with a strap holder which enables a strap, e.g. a Velcro strap, to pass through the device housing and around the patient's arm. The member (5) is placed against the skin above the damaged tendon and the device secured in place by tightening the strap. The device is activated by depression of the actuating button and deactivated by pressing the button once more.

Whilst the invention has been described in relation to epicondylitis it is believed that the concept presented herein also has applications in the treatment of tendonitis in general. Thus, viewed from a further aspect the invention provides a method of treating tendonitis in a patient suffering from tendonitis comprising applying to the part of the body afflicted by tendonitis a vibrating device, e.g. as hereinbefore described.

Viewed from another aspect the invention describes a kit comprising a vibrating device as hereinbefore defined and instructions for the use thereof in the treatment of tendonitis.

The invention will now be described in relation to the following non limiting examples

### Example

A patient suffering from epicondylitis has attached to his arm a device as shown in FIGS. 2 and 3. The device is activated and vibrates for 10 minutes. This treatment is repeated three times a day at 5 hourly intervals over a period of weeks.

The vibration therapy reduces the pain of epicondylitis experienced by the patient and accelerates recovery from the condition.

1. A method of treating epicondylitis comprising applying to the elbow of a patient suffering from epicondylitis a vibrating device.

2. A method of treating epicondylitis comprising vibrating the elbow using a vibrating device.

3. A method as claimed in claim 1 wherein the frequency of the vibration is 2 to 5 Hz.

4. A device for the treatment of epicondylitis comprising;
a housing;
a vibration generating device within the housing;
a vibration transmitting member projecting from the housing; and
a strap on the housing for holding the device against a patient's arm,
wherein the vibration transmitting member projects from the housing at a position which is spaced from the strap, so that the vibration transmitting member can supply vibrations to a patient's elbow when it is strapped to the patient's arm.

5. A device for the treatment of epicondylitis comprising;
a housing suitable for attachment to the arm of a patient and having at least one external surface; and
a vibrating member movably attached to the housing such that at least a part of the vibrating member projects from said external surface of the housing wherein in use the vibrating member is adapted to contact the elbow.

6. An epicondylitis treatment device comprising a housing arranged to contact the elbow and a vibrating means inside the housing, said vibrating means being adapted to vibrate at least a part of the device upon actuation.

7. A method of treating tendonitis in a patient suffering from tendonitis comprising applying to the part of the body afflicted by tendonitis a vibrating device

8. A kit comprising a vibrating device as described in claim 1 and instructions for the use thereof in the treatment of tendonitis or epicondylitis.
